(19) United States
(12) Patent Application Publication
(10) Pub. No.: US 2025/0364683 A1
(43) Pub. Date: Nov. 27, 2025

(54) BATTERY SAFETY SYSTEM HAVING A CONTROLLED GAS RELEASE FUNCTION

(71) Applicant: VOLKSWAGEN AG, Wolfsburg (DE)

(72) Inventors: Branislav Zlatkov, Braunschweig (DE); Marc Rüggeberg, Braunschweig (DE); Piotr Wrzuszczak, Hannover (DE)

(21) Appl. No.: 18/876,142

(22) PCT Filed: Jun. 20, 2023
(86) PCT No.: PCT/EP2023/066625

§ 371 Date: Dec. 17, 2024

(30) Foreign Application Priority Data
Jun. 22, 2022 (DE) 10 2022 115 583.8

(51) Int. Cl. H01M 50/30; B01D 53/04; H01M 10/42; H01M 50/342; H01M 50/358

(52) U.S. Cl. CPC H01M 50/394; B01D 53/0446; B01D 53/0454; H01M 10/425; H01M 50/3425; H01M 50/358; B01D 2253/34; B01D 2257/108; B01D 2257/2047; B01D 2257/502; B01D 2257/504; B01D 2257/7022; B01D 2257/7025; B01D 2257/80; H01M 2010/4271; H01M 2200/20

(57) ABSTRACT

A battery safety system for controlled, active gas release. The battery safety system includes a sorption element configured to absorb chemical compounds generated during gas release events, such as those caused by aging, leakage, or accidents. The system further includes a sensor or indicator configured to monitor the saturation state of the sorption element. Methods of using the battery safety system are also disclosed, including monitoring the saturation of the sorption element to ensure continued functionality and safety of the system. The use of the battery safety system in battery-powered transportation devices, household appliances, and large-scale electrochemical storage systems is also disclosed. Additionally, the use of a sensor or indicator for monitoring the saturation of sorption elements in battery systems is provided.

### RELATED APPLICATIONS

The present application claims priority to International Patent Application No. PCT/EP2023/066625 to Branislav Zlatko et al., filed Jun. 20, 2023, titled “Battery Safety System Having A Controlled Gas Release Function,” which claims priority to German Patent Application No. 10 2022 115 583.8, filed Jun. 22, 2022, the contents of each being incorporated by reference in their entirety herein.

### TECHNICAL FIELD

The present disclosure relates to a battery safety system for the controlled and active degassing. In many areas, the safety of batteries during charging, discharging, aging, leakage, thermal stress, mechanical damage or in the event of an accident plays a major role, for example also in traffic.

### BACKGROUND

As electromobility continues to advance, the requirements with regard to automotive batteries have also significantly increased. As a result of the improvement of the cell chemistry, cell performance was considerably increased over the last ten years in terms of energy density, power density, safety, and lifetime. One of the greatest challenges is to enhance cell safety such that an undesirable event would not result in major damage or does not pose a risk for the passengers and environment. Various measures are being explored that help to prevent a chain reaction and thermal propagation, thereby ensuring safety and robustness.

It is generally known that thermal runaway can occur in a cell in a battery system. This may lead to a chain reaction and additional cells may ignite. As a result, the entire battery system of a vehicle or of a means of transportation or a static storage design may be affected.

The gases that arise in the process can cause serious fires. It has proven to be problematic that the gas escaping from the individual cell housings initially propagates within the battery system and, via this propagating gas, thermal energy is transmitted to other cells.

Even if the formation of gas progresses slowly, the pressure in the cell increases, which results in swelling that can even lead to the plastic deformation of a cell. In addition, this battery cell may open up, whereby gases, vapors or electrolyte can leak in the battery module or battery system and can cause wide-ranging damage.

DE 10 2019 214 755 A1 proposes cooling the battery cells by means of a cooling circuit. A drying device, for example comprising silica gel or zeolite, ensures that no or little moisture can penetrate into the battery housing from the inside during pressure equalization. A penetration of moisture into the battery cells is also prevented in the other direction.

US 2013/0059175 A1 discloses a battery comprising a degassing system having a downwardly facing degassing opening, which leads into a collecting region for emerging decomposition products. The collecting region has a molding for removing the decomposition products. When leakage from the cell is slowed, however, the gases will remain in the system and collect in the collecting region, so that the risk of an explosive reaction is not reduced.

DE 10 157 272 C2 describes batteries comprising a non-combustible sorbent for the adsorption and absorption of organic solvents, for example. The sorbent is located in a region that is connected to the individual battery cells. It can be used in the form of granules or powder or in the form of a molded part. In addition, means for increasing the mechanical stability such as nets or nonwovens made, for example, of glass fibers or PTFE fibrids were described.

DE 10 2014 211 043 A1 discloses a lithium cell including film packaging in a hard shell cell housing and a fluorine absorber. The fluorine absorber is arranged in the film packaging and/or the hard shell cell housing, whereby hydrogen fluoride (HF), fluoride ions, and other fluorine-containing decomposition chemicals can be neutralized or bound close to or at the site where they arise. A development of HF is therefore also curbed directly at the generation site, in particular within the hard shell cell housing. The film packaging can have a metal-free and stretchable design, whereby a penetration of HF into the hard shell cell housing can be delayed without necessitating a degassing opening. However, the hard shell cell housing can also have a degassing opening, for example a safety rupture disk.

DE 10 2008 025 422 A1 describes an energy storage cell comprising a safety rupture disk and an absorber that is attached directly adjoining the same. This absorber can be an absorbent mass at the exit site of the electrolyte, for example in the form of dried tablets or a powder. When the safety rupture disk bursts, the leaking electrolyte is thus directly absorbed by the absorber.

DE 10 2011 087 198 A1 describes a battery cell comprising a closed degassing system, including an absorbent as well as a pressure valve or a configuration having a variable-volume gas receiving space to compensate for the pressure increase when gas forms.

Monitoring of the pressure relief in an enclosed, cell-like cavity by means of a sensor, for example when a cover unit is opened as a result of a pressure threshold being exceeded, is described in DE 20 2019 106 891 U1.

### SUMMARY

Aspects of the present disclosure are directed to improving existing battery systems or battery modules, in particular with respect to the safety. The escaping gases or chemically reactive compounds contained therein, such as H₂, CH₄, C₂H₂ and the like, or gaseous electrolyte components, are to be actively collected and then be removed. The changes are to enable the broad and safe usability of the battery systems for a wide variety of applications.

Aspects of the present disclosure also relate to a safety battery system having a controlled gas release function during states of a potential malfunction, such as, for example: charging, discharging, aging, leakage during thermal and/or electrical and/or mechanical stress or an accident, comprising at least one battery cell including a venting membrane, and a sorption element for taking up the chemical compounds arising during the gas release, characterized in that a sensor (preferably) or an indicator for monitoring the saturation of the sorption element is comprised.

In some aspects, the present disclosure also relates to the use of a sensor or an indicator for monitoring the saturation of sorption elements in battery systems, in particular also of sorption elements in the safety battery system according to the invention.

In some aspects, the present disclosure moreover relates to the use of the safety battery system according to the invention in rechargeable battery-operated means of transportation and household appliances and in large electrochemical storage facilities.

As used herein, the term “degassing” shall also encompass that gases, liquids or liquid vapors escape. The most frequent scenario during charging, discharging, aging, leakage during thermal and/or electrical and/or mechanical stress or an accident, however, is that gaseous compounds escape.

In some aspects, the present disclosure encompasses that a battery cell can have one or more venting membranes. The venting membranes are with or without a rupture disk, that is, continuous venting can take place. The position of the venting membrane is arbitrary. For illustration it shall be noted that the venting membranes have one or more openings that are covered by means of gas-permeable membrane.

If necessary, the venting membrane is designed in such a way that a burst function is made available.

Further preferred embodiments of the invention are derived from the remaining features described in drawings and claims provided herein.

The various embodiments described in the present application can advantageously be combined with one another, unless indicated otherwise in the specific instance.

### BRIEF DESCRIPTION OF THE DRAWINGS

Aspects of the present disclosure will be described hereafter in exemplary embodiments based on the associated drawings. In the drawings:

FIG. 1 shows a battery system according to a first configuration in a sectional view, according to some aspects of the present disclosure;

FIG. 2 shows a battery system according to a second configuration in a perspective view, according to some aspects of the present disclosure;

FIG. 3 shows a battery system according to a third configuration in a perspective view, according to some aspects of the present disclosure;

FIG. 4 shows a battery system according to the third configuration in a sectional view, according to some aspects of the present disclosure;

FIGS. 5a-d show two-dimensional views of different forms of a sorption element according to, some aspects of the present disclosure;

FIGS. 6 and 6a show a battery system according to a fourth configuration in two different sectional views, according to some aspects of the present disclosure; and

FIG. 7 shows an arrangement of a further configuration, according to some aspects of the present disclosure.

### DETAILED DESCRIPTION

The described embodiments may be combined with one another to achieve further advantages.

When a sorption element is used, hazardous gases or substances, such as CO₂, H₂, CO, CH₄, moisture, electrolyte vapors, or liquid components that may escape from the battery system, are effectively bound. This binding prevents uncontrolled propagation of such substances within the battery system. In the event of a damaging occurrence, sorption elements can significantly reduce or neutralize damage by permanently absorbing high-temperature, highly reactive gases or electrolyte fractions. For instance, in a thermal runaway scenario involving numerous battery cells, sorption elements can prevent ignition or uncontrolled propagation of gases, thereby minimizing the extent of damage.

The present disclosure also addresses the risk of sorption element saturation due to slow gas leakage, which can otherwise go undetected. By incorporating a sensor or indicator to monitor the saturation state of the sorption element, the present disclosure ensures detection of saturation before the sorption element becomes ineffective. Without such detection, additional gas or vapor could propagate through the battery system, and the sorption element may fail to absorb hazardous substances in the event of a serious incident.

In conventional systems, the sorption element must be replaced at predetermined intervals or upon saturation. Once removed for inspection, sorption elements often cannot be reused. The present disclosure eliminates unnecessary replacement and disposal of intact sorption elements, thereby reducing operating costs and labor while improving ecological sustainability.

The sorption element disclosed herein absorbs hazardous gases and substances, including CO₂, CO, CH₄, C₂H₆, HF, and electrolyte salts, such as lithium hexafluorophosphate. It also captures vapors of electrolyte components like ethylene carbonate, propylene carbonate, diethyl carbonate, and ethyl propionate, as well as acids and other hazardous media.

The sorption element contains a non-reactive material that may include various elements or compounds, introduced in multiple forms, such as granules, pellets, powder, green bodies, compacts, films, or membranes. To maximize the contact surface area between the sorption material and the substances flowing past it, the sorption element may adopt shapes such as rectangular, circular, oval, square, trapezoidal, or polygonal.

In a preferred embodiment, the venting membrane includes a vent opening.

In another preferred embodiment, the sensor used to monitor sorption element saturation may be a resistance sensor, optical sensor, or weight sensor. Multiple sensors using different measurement methods may be employed. These sensors include, but are not limited to, a resistance sensor that detects changes in the sorption element's electrical resistance upon saturation, an optical sensor that detects changes in light extinction or translucency, and/or a weight sensor that measures changes in the sorption element's weight.

The sensor or indicator may operate based on other physical principles and is preferably connected to a battery management control unit. The control unit processes sensor data to determine the saturation state of the sorption element and outputs an indication when a saturation threshold is reached, signaling the need for replacement.

In a preferred embodiment of the invention, the sensor or indicator according to the invention is connected to a battery management control unit, which can ascertain and output the saturation of the sorption element based on the data detected by the sensor. Advantageously, a necessary replacement of the sorption element can be indicated when the ascertained value exceeds a saturation limit value.

In a further preferred embodiment, the sorption element is non-hydrophilic, meaning the material responsible for absorption or adsorption does not attract water. This property makes the sorption element particularly suitable for capturing compounds such as H₂, CH₄, C₂H₆, and organic solvents, which are most likely to escape from battery cells. Alternatively, the sorption element may have a hybrid composition to allow moisture absorption when necessary.

In another embodiment, the venting membrane is positioned on the top side of the battery cell. This ensures the degassing device faces upward during operation, as commonly seen in automotive applications.

In a preferred configuration of the safety battery system, a protection space is provided to prevent the ingress of impurities, such as splashing water, into the battery cell through the venting membrane. For example, a battery tray may form this protection space. The protection space increases battery cell protection and allows the distance between the sorption element and the battery cell interior to be increased. This additional spacing cools escaping substances before they are bound by the sorption element, improving its effectiveness and durability.

In one embodiment, the sorption element is positioned within the protection space at its exit, viewed in the degassing flow direction. This maximizes the spacing between the battery cell interior and the sorption element, enabling the escaping gases or vapors to cool further before absorption, thereby conserving the sorption element.

In a further embodiment, the protection space is shaped as a channel, and the sorption element fills the entire cross-section of the channel in the venting flow direction. This configuration ensures controlled gas release, as it minimizes mixing of the escaping gases. Reduced mixing prevents undesirable reactions between gases that may arise during a battery event.

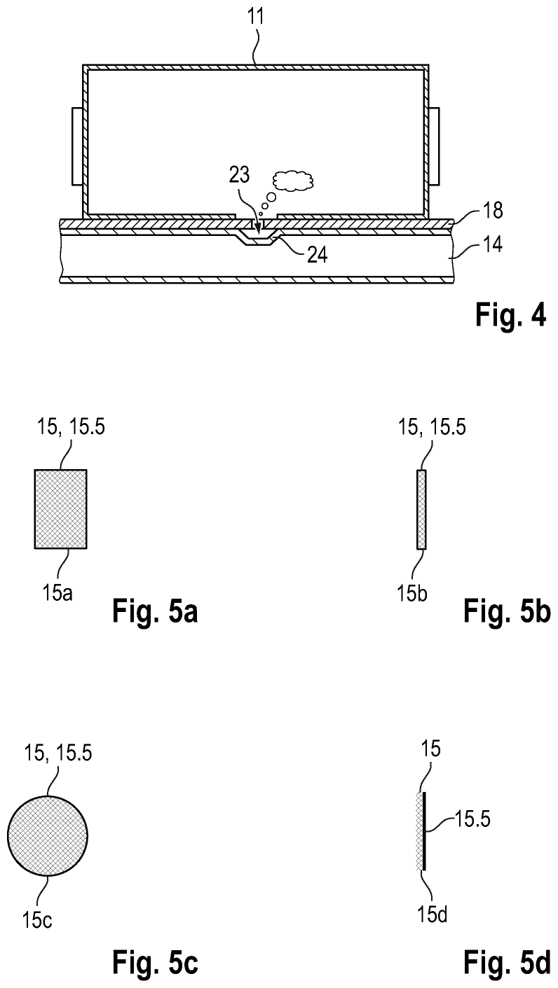

In another variation of the protection space embodiment, a mat is provided on the outside of the venting membrane-between the battery cell housing and the floor opening of the protection space. The sorption element is integrated into this mat. The mat also serves as a seal between the battery cell housing and the protection space, such as a battery tray. This dual-purpose configuration allows easy replacement of the sorption element along with the gasket, thereby ensuring a long, safe operational life for the battery system. This configuration is illustrated in FIG. 4.

In another preferred embodiment of the safety battery system according to the invention, at least two sorption elements are comprised, which are located at different positions between groups of battery cells. Such an embodiment is shown in FIG. 3. The advantage is that it is not necessary to provide one sorption element per battery cell, but that the compounds that arise during degassing is nonetheless sufficiently absorbed. This saves sorption elements. Accordingly, these can be placed in distributed positions. Advantageously, it is even possible to select the placement at sites at which the probability of leakage is the greatest, for example due to impact or due to the action of heat.

In a preferred embodiment, the sorption element has a shape selected from a cuboid shape, a rectangular shape and a cylindrical shape, and the sorption element is located in a net-like carrier. The advantage is that the sorption element is retained, that is, is stationary, without the surface thereof being unnecessarily covered and eluding adsorption or absorption. The reason is that the absorbable amount of compound(s) is thus greater than if parts of the sorption element were covered.

In another preferred embodiment of the invention, the sorption element has a flat shape and is applied onto a membrane (serving as a net-like carrier). Advantageously, a flown-through cross-section can thus be provided with a uniformly distributed (because uniformly thick) sorption element, so that the sorption element can withstand the circumstances even with larger pressure of the arising compounds, that is, large quantities, and does not lose the shape thereof and also does not break since it is supported by the membrane preferably located therebehind (in the flow direction).

In a further preferred embodiment, the material used in the sorption element is selected from physical adsorbents and chemical adsorbents. Physical adsorbents include materials such as zeolites, silica materials, metal organic frameworks (MOFs), activated carbon, covalent organic frameworks (COFs), molecular sieving carbon, alkali metal/metal oxide-based materials, ordered porous carbon, activated carbon fibers (ACF), graphene, carbon molecular sieves (CMS), and composite materials of the aforementioned substances.

Chemical adsorbents include composite adsorbents that may be impregnated with potassium carbonate (K₂CO₃), binary eutectic mixtures (such as KNO₃ and LiNO₃), sodium nitrate (NaNO₃), aluminum oxide (Al₂O₃), zirconium oxide (ZrO₂), titanium dioxide (TiO₂), manganese dioxide (MnO₂), zinc oxide (ZnO), or ionic liquids (IL). Additionally, aqueous amines can be incorporated into a carrier adsorbent matrix. Examples of aqueous amines include tetraethylenepentamine (TEPA), poly (allylamine) (PAA), polyethylene imine (PEI), ethylenediamine (EDA), diethylenetriamine (DETA), pentaethylenehexamine (PEHA), aminopropyl (AP), monoethanolamine (MEA), lysine, glycine, proline, alanine, arginine, triethylenetetramine (TETA), and 2-amino-2-methyl-1-propanol (AMP), among others.

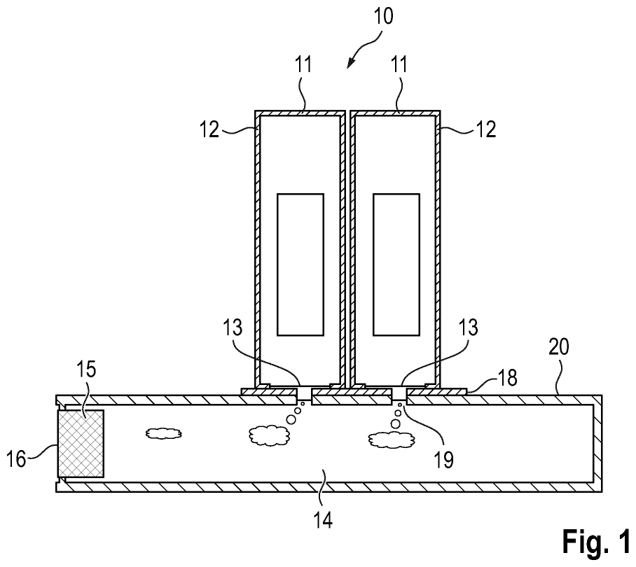

FIG. 1 serves to illustrate a first exemplary embodiment of a battery system 10 comprising two battery cells 11 arranged directly adjacent to one another, with the view directed at a pole side of the cell housing 12. It is apparent in the representation that each battery cell 11 has a venting membrane 13, which in the present case faces downwardly, so that gases, vapors, media, and the like can propagate into the protection space 14 (clearance protection space) and thereafter reach the sorption element 15 (here in the form of an adsorber unit), where they can be adsorbed. The sorption element 15 can be positioned in any arbitrary manner. In the embodiment of FIG. 1, the sorption element 15 is an integral part of the exit of the protection space 16 (that is, of the main vent) of the battery system. A mat 18 is formed between the cell housing 12 or the venting membranes 13 thereof and the floor opening 19 in the battery tray 20.

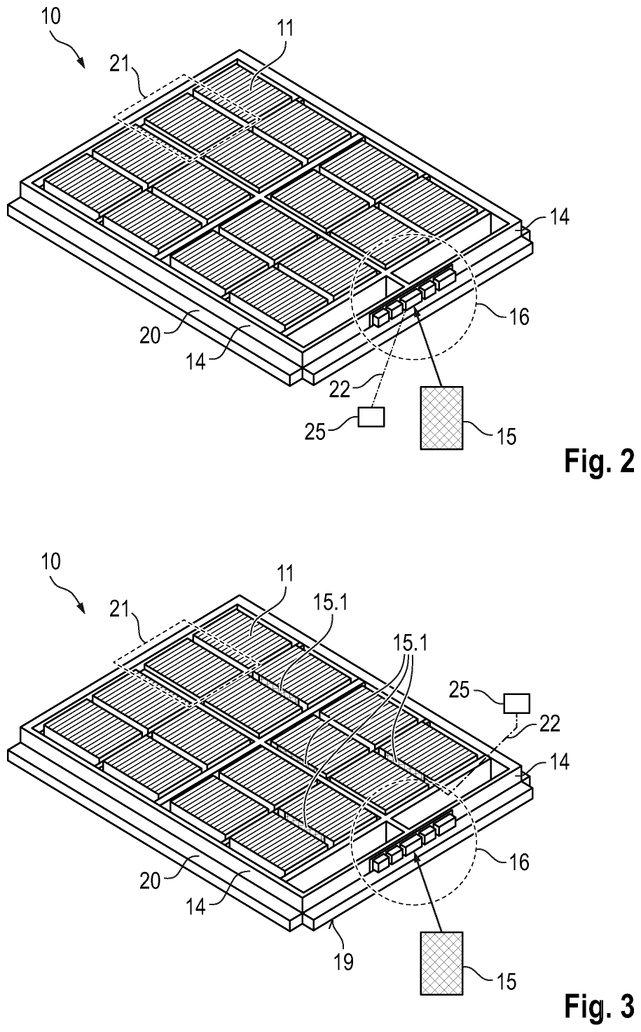

FIG. 2 shows an entire module, which is assembled from multiple groups of battery systems 21, in a second exemplary embodiment. Each of the groups 21 is made up of twelve battery cells 11. In total, there are 192 battery cells installed in the battery tray 20. The venting membranes 13 of the battery cells face downwardly, as shown in FIG. 1. The main vent 16, which includes one or more sorption elements 15 in the clearance protection space, serving as the protection space 14, is located on the side of the battery system 10 (see arrow) and serves as the exit of the protection space. The protection space 14 can have a different design and be distributed among multiple groups. It is then possible to introduce the sorption element 15 not only in a central location but also in arbitrary locations. The sorption element 15 is made up of a material matrix which, when the sorbent material contained therein approaches saturation during adsorption or absorption, indicates a corresponding change in internal resistance. In the process, a signal is forwarded via a feed line (between the sorption element and the battery management control unit) 22 to the battery management control unit (BMS), indicating that the sorption elements 15 are saturated and must be replaced.

The material matrix of the sorption element involves complex material mixtures that are dependent on the type of cell chemistry (NMC, LFP and the like), use, design and the like. It is safe to assume that a large number of the following material combinations (known from literature) may be used:
physical adsorbents, such as: zeolites, silica materials, metal organic framework (MOF), activated carbon, covalent organic framework (COF) or molecular sieving carbons, materials based on alkali metals/metal oxides, ordered porous carbon, activated carbon fibers (ACF), graphene, carbon molecular sieve (CMS), and the composite materials thereof, and the like;
chemical adsorbents: composite adsorbents, produced by impregnation with K₂CO₃, binary eutectic mixture (KNO₃ and LiNO₃), NaNO₃, Al₂O₃, ZrO₂, TiO₂, MnO₂, ZnO, ionic liquid (IL), and aqueous amine (that is, tetraethylenepentamine (TEPA), poly (allylamine) (PAA), polyethylene imine (PEI), ethylenediamine (EDA), diethylenetriamine (DETA), pentaethylenehexamine (PEHA), aminopropyl (AP), monoethanolamine (MEA), lysine, glycine, proline, alanine, arginine, triethylenetetramine (TETA) and 2-amino-2-methyl-1-propanol (AMP) and the like in the carrier adsorbent matrix, and the like.

The material matrix can be arbitrarily combined from various components, essentially representing an adsorber compound.

FIG. 3 shows a third embodiment of the invention for the case in which leakage arises at an arbitrary cell location and gases, vapors, and the like propagate uncontrolled from the cell in the battery system between the battery cell 11, without finding their way downward into the protection space 14. They are discharged directly to the outside. This means that, in terms of design, no floor openings 19 are present in the floor of the battery tray 20. Instead, the protection space is designed as a channel 23, as shown in FIG. 4. The channel base 24, in this case, acts as a barrier, allowing hazardous gases, vapors, and the like to remain contained and preventing them from causing undesirable damage to the vehicle, its occupants, or the environment. In this embodiment, the sorption element 15 is installed in different positions 15.1 between groups of battery cells 21. The size and shape of the sorption elements 15.1 can be selected arbitrarily. They are composed of the same materials as in exemplary embodiment 2.

FIG. 5 shows different shapes (2D representation) of the sorption element 15, which is filled with a sorption material/sorbent (pellets and/or powder and/or granules, and the like). The sorption element can have a cuboid shape 15a, a rectangular shape 15b, a cylindrical shape 15c, or a membrane shape 15d. For the cuboid, rectangular, and cylindrical shapes, the sorption material of the sorption element is contained in a net-like carrier 15.5 that serves as a carrier pouch (container), which is made of a permeable net. In embodiment d) in FIG. 5, the sorption element 15 has a flat shape, which is applied (coated) to a membrane in the form of a net-like carrier 15.5. We assume that other designs are also possible.

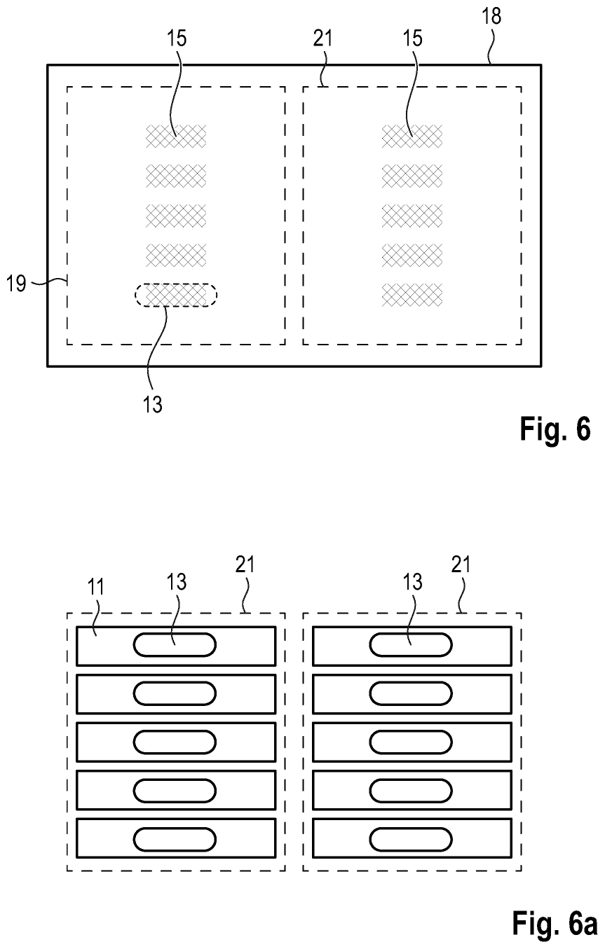

FIGS. 6 and 6a show another exemplary embodiment in which the sorption element 15 is integrated into the mat 18 to match the venting membranes 13 of the particular cell 11 within the group of battery cells 19.

FIG. 6 shows the plane of the mat beneath the groups of battery cells.

FIG. 6a shows a plane further up on the underside of the groups of battery cells, including the venting membranes 13. FIG. 6a schematically visualizes the interface between the battery cell group 21 and the battery cells 11, as well as the mat 18. The illustrated sorption elements 15 have a rectangular basic shape in this embodiment. However, any other shape is also possible, particularly circular, oval, square, trapezoidal, polygonal, or other basic shapes.

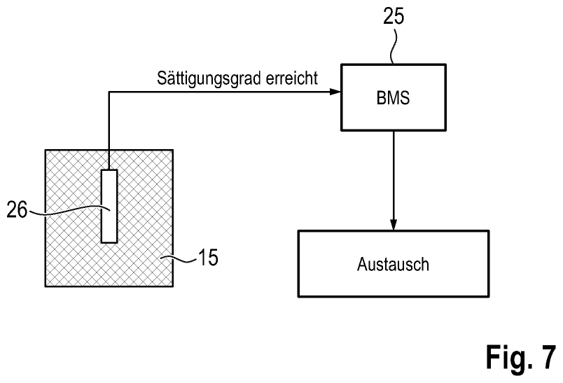

FIG. 7 schematically shows a sensor or indicator 26, which is connected to the sorption element 15 and can indicate the saturation of the sorption element 15, signaling a necessary replacement to the battery management system 25.

### LIST OF REFERENCE NUMERALS

10 safety battery system
11 battery cell
12 battery cell housing
13 venting membrane
14 protection space
15 sorption element
15.1 sorption element in different positions
15.5 net-like carrier
15a cuboid shape
15b rectangular shape
15c cylindrical shape
15d membrane shape
16 exit of the protection space (main vent)
18 mat
19 floor opening of the battery tray
20 battery tray (special design of the protection space)
21 groups of battery systems
22 feed line between sorption element and battery management control unit
23 protection space designed as channel
24 channel base
25 battery management control unit
26 sensor or indicator

1-14. (canceled)

15. A safety battery system configured for controlled gas release during aging, leakage, or an accident, the system comprising:
at least one battery cell having a venting membrane;
a sorption element configured to absorb chemical compounds released during degassing; and
a sensor or an indicator configured to monitor a saturation state of the sorption element.

16. The safety battery system of claim 15, wherein the sensor comprises one or more of a resistance sensor, an optical sensor, and a weight sensor.

17. The safety battery system of claim 15, wherein the sorption element is non-hydrophilic.

18. The safety battery system of claim 15, wherein the venting membrane is positioned on a top side of the battery cell.

19. The safety battery system of claim 15, further comprising a protection space configured to protect the battery cell against ingress of impurities, wherein the protection space is located at the venting membrane.

20. The safety battery system of claim 19, wherein the sorption element is positioned within the protection space at an exit thereof.

21. The safety battery system of claim 19, wherein the protection space comprises a channel shape, and the sorption element is positioned to fill the channel across an entire cross-section in a venting flow direction.

22. The safety battery system of claim 19, further comprising a mat positioned outside the venting membrane between the battery cell and the protection space, wherein the sorption element is integrated into the mat.

23. The safety battery system of claim 15, further comprising at least two sorption elements positioned at different locations between groups of battery cells.

24. The safety battery system of claim 15, wherein the sorption element comprises a shape comprising one or more of a cuboid shape, a rectangular shape, and a cylindrical shape, and wherein the sorption element is positioned within a net-like carrier.

25. The safety battery system of claim 15, wherein the sorption element comprises a flat shape and is applied to a membrane configured as a net-like carrier.

26. The safety battery system of claim 15, wherein the sensor or indicator is coupled to a battery management control unit, the battery management control unit being configured to ascertain and output the saturation state of the sorption element.

27. A method for controlling gas release during aging, leakage, or an accident in a safety battery system, the method comprising:
providing at least one battery cell having a venting membrane;
positioning a sorption element configured to absorb chemical compounds released during degassing within the safety battery system; and
monitoring a saturation state of the sorption element using a sensor or an indicator.

28. The method of claim 27, wherein monitoring the saturation state of the sorption element comprises utilizing one or more of a resistance sensor, an optical sensor, and a weight sensor.

29. The method of claim 27, further comprising:
positioning the sorption element within a protection space located at the venting membrane, wherein the protection space is configured to protect the battery cell against ingress of impurities.

30. The method of claim 29, wherein the sorption element is positioned to fill a channel within the protection space, the channel being configured to direct gas flow and minimize mixing of released chemical compounds.

31. A safety battery system for use in rechargeable battery-operated transportation devices, household appliances, or electrochemical mass storage facilities, the system comprising:
at least one battery cell having a venting membrane;
a sorption element configured to absorb chemical compounds released during degassing of the at least one battery cell; and
a sensor or an indicator configured to monitor a saturation state of the sorption element, wherein the sorption element is positioned within the safety battery system to control gas release during aging, leakage, or an accident.

32. The safety battery system of claim 31, wherein the sorption element is positioned within a protection space located at the venting membrane, the protection space being configured to protect the at least one battery cell from ingress of impurities.

33. The safety battery system of claim 31, wherein the sorption element comprises a shape comprising one or more of a cuboid shape, a rectangular shape, and a cylindrical shape, and wherein the sorption element is positioned within a net-like carrier.

34. The safety battery system of claim 31, wherein the sensor comprises one or more of a resistance sensor, an optical sensor, and a weight sensor, and wherein the sensor is coupled to a battery management control unit configured to ascertain and output the saturation state of the sorption element.
